(19) United States
(12) Patent Application Publication
(10) Pub. No.: US 2026/0148980 A1
(43) Pub. Date: May 28, 2026

(54) CATHODE ACTIVE MATERIAL AND METHOD FOR MANUFACTURING THE SAME

(71) Applicants: HYUNDAI MOTOR COMPANY, Seoul (KR); Kia Corporation, Seoul (KR); KOREA ELECTRONICS TECHNOLOGY INSTITUTE, Seongnam-si (KR)

(72) Inventors: Jae Seong HWANG, Hwaseong-si (KR); Young Jun HONG, Hwaseong-si (KR); Kyung Yup SONG, Hwaseong-si (KR); Ye Seul PARK, Hwaseong-si (KR); Sang Hun JEONG, Hwaseong-si (KR); Do Yun KWON, Hwaseong-si (KR); Byoung Cheon JEONG, Hwaseong-si (KR); So Yeon PARK, Hwaseong-si (KR); Kyung Su KIM, Yongin-si (KR); Woo Suk CHO, Seongnam-si (KR); Ji Sang YU, Seoul (KR); Yun Chae JUNG, Yongin-si (KR); Keon Ho PARK, Seongnam-si (KR); Seung Ho CHOI, Seoul (KR)

(73) Assignees: HYUNDAI MOTOR COMPANY, Seoul (KR); Kia Corporation, Seoul (KR); KOREA ELECTRONICS TECHNOLOGY INSTITUTE, Seongnam-si (KR)

(21) Appl. No.: 19/237,976

(22) Filed: Jun. 13, 2025

(30) Foreign Application Priority Data
Nov. 27, 2024 (KR) 10-2024-0172700

(51) Int. Cl. H01M 4/525; H01M 4/02; H01M 10/0562

(52) U.S. Cl. CPC H01M 4/525; H01M 10/0562; H01M 2004/021; H01M 2004/028; H01M 2300/0068

(57) ABSTRACT

A cathode active material includes a lithium composite metal oxide and a solid electrolyte layer which surrounds the lithium composite metal oxide, and the solid electrolyte layer includes a sulfide-based solid electrolyte doped with oxygen.

### CROSS-REFERENCE TO RELATED APPLICATION

This application claims the benefit of priority to Korean Patent Application No. 10-2024-0172700, filed in the Korean Intellectual Property Office on Nov. 27, 2024, the entire contents of which are incorporated herein by reference.

### TECHNICAL FIELD

The present disclosure relates to a cathode active material and a method for manufacturing the same, and more particularly, relates to a cathode active material for an all-solid state battery.

### BACKGROUND

A lithium secondary battery has been developed as a small-size power supply for a smartphone and a small-size electronic device, and the demand for the lithium secondary battery has been increased, as an electric vehicle is developed.

The lithium secondary battery includes cathode and anode materials to exchange a lithium ion, and an electrolyte to transfer the lithium ion. A general lithium ion battery employs a liquid electrolyte obtained by dissolving a lithium salt into an organic solvent, and a membrane including organic fiber to prevent physical contact between the cathode and the anode such that a short circuit is prevented. Since the organic solvent having flammability is used as an electrolyte solvent, when the short circuit is caused due to the physical damage, the probability of fire or explanation is increased, and a large number of accidents are actually caused.

The all-solid state battery includes an inorganic solid electrolyte which is substituted with a liquid electrolyte having flammability. The inorganic solid electrolyte mainly includes an oxide-based electrolyte and a sulfide-based electrolyte. Among them, the sulfide-based solid electrolyte has been spotlighted because the sulfide-based solid electrolyte has higher lithium ion conductivity approximate to lithium ion conductivity of the liquid electrolyte.

However, the sulfide-based solid electrolyte causes a side reaction on the interface between a cathode material and an electrolyte to degrade battery performance. Accordingly, to prevent the side reaction, there is required a solid-electrolyte material stably present on a cathode material surface, with lithium ion mobility between the cathode material and the solid-electrolyte interface. In addition, a surface coating process technology of the cathode active material should be employed to ensure the higher contact ratio between the cathode active material and the solid electrolyte.

### PRIOR ART

### Patent Documents

(Patent document 1) US Patent application No. US 2023/0187620 A

### SUMMARY

The present disclosure has been made to solve the above-mentioned problems occurring in the prior art while advantages achieved by the prior art are maintained intact.

An aspect of the present disclosure provides a cathode active material including a solid electrolyte layer, which contributes to suppressing a side reaction made on the interface between a cathode material and a solid electrolyte, reducing the internal resistance of an electrode, and improving higher-temperature stability and performance of the cathode material, and a method for manufacturing the same.

The technical problems to be solved by the present disclosure are not limited to the aforementioned problems, and any other technical problems not mentioned herein will be clearly understood from the following description by those skilled in the art to which the present disclosure pertains.

(1) The present disclosure provides a cathode active material including a core including a lithium composite metal oxide, and a solid electrolyte layer provided on the core. The solid electrolyte layer includes a sulfide-based solid electrolyte doped with oxygen.
(2) The present disclosure provides a cathode active material in which a weight of the solid electrolyte layer ranges from about 0.01 wt % to about 6 wt %, based on a whole weight of the lithium composite metal oxide in (1).
(3) The present disclosure provides a cathode active material in which the solid electrolyte layer has a peak which is observed while ranging from 532.5 eV to 533 eV, when the solid electrolyte layer is analyzed through an X-ray photoelectron spectroscopy (XPS) in (1) or (2).
(4) The present disclosure provides a cathode active material in which the sulfide-based solid electrolyte doped with the oxygen includes thiophosphate (PS₃O³⁻) in any one of (1) to (3).
(1) (5) The present disclosure provides a cathode active material in which the sulfide-based solid electrolyte is expressed as following Chemical formula 2, in any one of (1) to (4).

Li₇₋ₐPS₆₋ₐXₐ, [Chemical formula 2]

in which 0 ≤a≤2 and ‘X’ is any one of Cl, Br, or I in Chemical formula 2.
(6) The present disclosure provides a cathode active material in which the core is obtained by coating LiNbO₃ on the lithium composite metal oxide, in any one of (1) to (5).
(7) The present disclosure provides a cathode active material in which the solid electrolyte layer has a thickness of at most 200 nm, in any one of (1) to (6).
(8) The present disclosure provides a cathode including the cathode active material and the sulfide-based solid electrolyte in any one of (1) to (7).
(9) The present disclosure provides a cathode in which the sulfide-based solid electrolyte is not doped with oxygen, in (8).
(10) The present disclosure provides a method for manufacturing a cathode active material, which includes preparing lithium composite metal oxide and sulfide-based solid electrolyte powders (S1), and coating the sulfide-based solid electrolyte powders on the lithium composite metal oxide under the atmosphere of oxygen (O₂) (S2).
(11) The present disclosure provides a method for manufacturing a cathode active material, in which ‘S2’ is performed a Hybridizer process in ‘S2’

### BRIEF DESCRIPTION OF THE DRAWINGS

The above and other objects, features and advantages of the present disclosure will be more apparent from the following detailed description taken in conjunction with the accompanying drawings:

FIG. 1 is a view schematically illustrating a cathode including a cathode active material, according to an embodiment of the present disclosure;

FIG. 2 is a view schematically illustrating a process for manufacturing a cathode active material, according to an embodiment of the present disclosure;

FIG. 3 is an image illustrating an EDS analysis result for a cathode active material of Embodiment 1;

FIG. 4 is an image illustrating an EDS analysis result for a cathode active material of Comparative example 2;

FIG. 5 is a graph illustrating an XPS analysis result for each of the cathode active materials manufactured Embodiment 2 and Comparative example 1;

FIG. 6 is a graph illustrating an XRD analysis result for each of cathode active materials manufactured in Embodiment 2, and Reference examples 1 and 2;

FIG. 7 is a graph illustrating a charging/discharging capacity of each all-solid state battery manufactured using a cathode active material manufactured in Embodiment 1 and Comparative example 1;

FIG. 8 is a graph illustrating a charging/discharging capacity in each cycle when a primary cycle is performed with 0.1 C/0.1 C, and a secondary cycle is performed with 0.5 C/0.5 C at the temperature of 60° C. with respect to an all-solid state battery manufactured using the cathode active material manufactured in Embodiment 1;

FIG. 9 is a graph illustrating a charging/discharging capacity in each cycle when a primary cycle is performed with 0.1 C/0.1 C, and a secondary cycle is performed with 0.5 C/0.5 C at the temperature of 60° C. with respect to an all-solid state battery manufactured using the cathode active material manufactured in Comparative example 1;

FIG. 10 is a graph illustrating the change in capacity as a function of a cycle number when a cycle of 0.5 C/0.5 C was performed 50 times at the temperature of 60° C., with respect to each of all-solid state batteries manufactured using cathode active materials manufactured in Embodiment 1 and Comparative example 1;

FIG. 11 illustrates a graph of a charging/discharging capacity, as charging was performed by changing a rate to 1 C, 2 C, 5 C, and 10 C step by step, and discharging was performed at the rate of 0.5 C, with respect to the all-solid state battery manufactured using the cathode active material manufactured by Embodiment 1;

FIG. 12 illustrates a graph of a charging/discharging capacity, as charging was performed by changing a rate to 1 C, 2 C, 5 C, and 10 C step by step, and discharging was performed at the rate of 0.5 C, with respect to the all-solid state battery manufactured using the cathode active material manufactured in Comparative Example 1; and

FIG. 13 illustrates a graph of a charging/discharging capacity, as charging was performed by changing a rate to 1 C, 2 C, 5 C, and 10 C step by step, and discharging was performed at the rate of 0.5 C, with respect to the all-solid state battery manufactured using the cathode active material manufactured in Comparative Example 2.

### DETAILED DESCRIPTION

Hereinafter, the present disclosure will be described in more detail for the understanding of the present disclosure. In this case, terms and words used in the present specification and the claims shall not be interpreted as commonly-used dictionary meanings, but shall be interpreted as to be relevant to the technical scope of the present disclosure based on the fact that the inventor may properly define the concept of the terms to explain the invention in best ways.

The terms used in the present disclosure are provided only for the illustrative purpose, and the present disclosure is not limited thereto. The singular forms are intended to include the plural forms unless the context clearly indicates otherwise.

### <Cathode Active Material>

The present disclosure provides a cathode active material.

According to an embodiment of the present disclosure, the cathode active material includes a core CAM at least containing a lithium composite metal oxide and a solid electrolyte layer 100, which surrounds the core CAM, and the solid electrolyte 100 layer includes a sulfide-based solid electrolyte doped with oxygen.

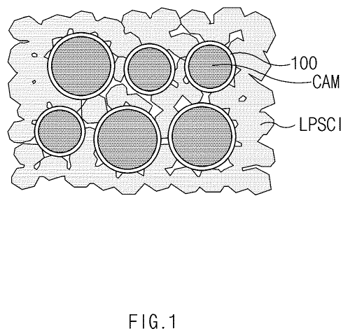

FIG. 1 is a view schematically illustrating a cathode including a cathode active material, according to an embodiment of the present disclosure.

Referring to FIG. 1, according to an embodiment of the present disclosure, the cathode active material may include the solid electrolyte layer 100 provided on the core CAM. In addition, according to an embodiment of the present disclosure, the cathode may include the cathode active material and a sulfide-based solid electrolyte (LPSCI) provided around the cathode active material. When the sulfide-based solid electrolyte (LPSCI) present in the cathode directly makes contact with the core CAM, a side reaction may be made on an interface between the sulfide-based solid electrolyte (LPSCI) and the core CAM to degrade the performance of an all-solid state battery (cell).

Inventors of the present disclosure find out that when the cathode active material is manufactured by coating the solid electrolyte layer 100 including a solid electrolyte doped with oxygen, to the core CAM, an area of the contact between the sulfide-based solid electrolyte (LPSCI) and the cathode active material is increased, thereby reducing the internal resistance of the electrode and suppressing the side reaction between the cathode active material and the sulfide-based solid electrolyte (LPSCI), and complete the present disclosure.

Hereinafter, the cathode active material according to an embodiment of the present disclosure and components constituting the cathode including the same will be described in detail.

### 1. Core

According to an embodiment of the present disclosure, the core CAM of the cathode active material may include a lithium composite metal oxide.

According to an embodiment of the present disclosure, the lithium composite metal oxide may include a rock salt type active material, such as LiCoO₂, LiMnO₂, LiNiO₂, LiVO₂, Li₁₊ₓNi_{1/3}Co_{1/3}Mn_{1/3}O₂, a spinel type active material, such as LiMn₂O₄, Li(Ni_{0.5}Mn_{1.5})O₄, reverse spinel type active material, such as LiNiVO₄, or LiCoVO₄, an olivine-type active material, such as LiFePO₄, LiMnPO₄, LiCoPO₄, or LiNiPO₄, a silicon-containing active material, such as Li₂FeSiO₄, Li₂MnSiO₄, a rock salt type active material, such as LiNi_{0.8}Co_{(0.2-x)}AlₓO₂ (0<x<0.2), which is obtained by substituting a portion of transition metal with a heterogeneous metal, a spinel-type active material, such as Li₁₊ₓMn_{2-x-y}M_{y}O₄ (M is at least one of Al, Mg, Co, Fe, Ni, and Zn; 0<x+y<2), which is obtained by substituting a portion of the transition metal with a heterogeneous metal, or lithium titanate such as Li₄Ti₅O₁₂.

According to an embodiment of the present disclosure, the lithium composite metal oxide may include a compound expressed as following Chemical formula 1

LiNi_{1-x-y}CoₓMn_{y}O₂ (0<x,0<y,0<x+y<1) [Chemical formula 1]

According to an embodiment of the present disclosure, the core CAM may be obtained by additionally coating at least one selected from the group consisting of LiNbO₃, LiV₃O₈, Li₂ZrO₃ and the combination thereof, to the lithium composite metal oxide. Accordingly, the side reaction on the interface may be reduced to more improve the structural stability.

### 2. Solid Electrolyte Layer

According to an embodiment of the present disclosure, the cathode active material may include the solid electrolyte layer 100 provided on the core CAM. The solid electrolyte layer 100 is provided on the core CAM to prevent the side reaction between the sulfide-based solid electrolyte (LPSCI) and the core CAM while increasing the area of the contact between the sulfide-based solid electrolyte (LPSCI) and the cathode active material, thereby reducing the internal resistance of the electrode.

According to an embodiment of the present disclosure, the sulfide-based solid electrolyte (LPSCI), which is not doped with oxygen, may include Li₂S—P₂S₅, Li₆PS₅Cl_{0.5}Br_{0.5}, Li₂S—P₂S₅—LiI, Li₂S—P₂S₅—LiCl, Li₂S—P₂S₅—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S-SiS₂—P₂S₅—LiI, Li₂S—B₂S₃, Li₂S—P₂S₅—ZₘSₙ (in which ‘m’ and ‘n’ are positive numbers, ‘Z’ is one of Ge, Zn, and Ga), or Li₁₀GeP₂S₁₂

According to an embodiment of the present disclosure, the sulfide-based solid electrolyte (LPSCI), which is not doped with oxygen, may be, in detail, a compound expressed in following Chemical formula 2.

Li₇₋ₐPS₆₋ₐXₐ [Chemical formula 2]

In Chemical formula 2, 0≤a≤2 and ‘X’ is any one of Cl, Br, or I.

According to an embodiment of the present disclosure, the solid electrolyte layer 100 may include a sulfide-based solid electrolyte doped with oxygen. The sulfide-based solid electrolyte (LPSCI) doped with oxygen refers to that the sulfide-based solid electrolyte (LPSCI) doped with oxygen has a composition different from that of a general sulfide-based solid electrolyte (LPSCI), as the sulfide-based solid electrolyte (LPSCI) is coated on the core CAM under an ‘oxygen atmosphere’ in the manufacturing method described below. In detail, in the sulfide-based solid electrolyte doped with oxygen, a sulfur (S) atom is substituted with an oxygen (O) atom in relation to a sulfide-based composition (PS₄³⁻) to form thiophosphate (PS₃O³⁻). Accordingly, the side reaction between the core CAM and the sulfide-based solid electrolyte (LPSCI) may be suppressed without reducing the ion conductivity of the cathode active material.

According to an embodiment of the present disclosure, as the solid electrolyte layer 100 includes the sulfide-based solid electrolyte doped with oxygen, the solid electrolyte layer 100 may have a peak which is observed while ranging from 532.5 eV to 533 eV, when analyzed through an X-ray photoelectron spectroscopy (XPS). The observation of the peak ranging from 532.5 eV to 533 eV in the XPS analysis is caused due to the presence of phosphoric acid, which proves that oxygen is doped in the sulfide-based solid electrolyte (LPSCI).

According to an embodiment of the present disclosure, the solid electrolyte layer 100 may have the thickness ranging from about 50 nm to about 200 nm. In detail, the solid electrolyte layer 100 may have the thickness of at least about 55 nm, at least about 60 nm, at least about 65 nm, at least about 70 nm, at least about 75 nm, or at least about 80 nm, and may have the thickness of at most about 195 nm, at most about 190 nm, at most about 185 nm, at most about 180 nm, at most about 175 nm, or at most about 170 nm. Accordingly, when the range is satisfied, the side reaction between the core CAM and the sulfide-based solid electrolyte (LPSCI) may be suppressed without reducing the ion conductivity of the cathode active material.

According to an embodiment of the present disclosure, the solid electrolyte layer 100 may be included in the cathode active material, in content ranging about 0.01 wt % to about 6 wt %, based on the weight of the core CAM. In detail, the solid electrolyte layer 100 may be included in the cathode active material, in content of at least about 0.02 wt %, at least about 0.04 wt %, at least about 0.06 wt %, at least about 0.08 wt %, at least about 0.1 wt %, at least about 0.12 wt %, at least about 0.14 wt %, at least about 0.16 wt %, at least about 0.18 wt %, or at least about 0.2 wt %, and at most about 5.8 wt %, at most about 5.6 wt %, at most about 5.4 wt %, at most about 5.2 wt %, at most about 5 wt %, at most about 4.8 wt %, at most about 4.6 wt %, at most about 4.4 wt %, at most about 4.2 wt %, or at most about 4 wt %, based on the weight of the core CAM. Accordingly, when the range is satisfied, the side reaction between the core CAM and the sulfide-based solid electrolyte (LPSCI) may be suppressed without reducing the ion conductivity of the cathode active material.

### <Method for Manufacturing Cathode Active Material>

The present disclosure provides a method for manufacturing the cathode active material.

The method for manufacturing the cathode active material according to an embodiment of the present disclosure, includes preparing a lithium composite metal oxide, and sulfide-based solid electrolyte powders (S1) and coating the sulfide-based solid electrolyte powders on the lithium composite metal oxide under the atmosphere of oxygen (O₂) (S2).

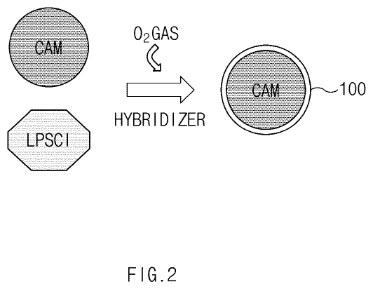

FIG. 2 is a view schematically illustrating a process for manufacturing a cathode active material according to an embodiment of the present disclosure. Hereinafter, each step of the method for manufacturing the cathode active material according to an embodiment of the present disclosure will be described with reference to FIG. 2.

### 1. ‘S1’

According to an embodiment of the present disclosure, the method for manufacturing the cathode active material includes preparing a lithium composite metal oxide, and sulfide-based solid electrolyte powders (S1).

According to an embodiment of the present disclosure, the lithium composite metal oxide, which is to form the core CAM of the cathode active material, may be prepared through a well-known manner (for example, co-precipitation reaction)

According to an embodiment of the present disclosure, the sulfide-based solid electrolyte powders, which are to form the solid electrolyte layer 100 of the cathode active material, may not be doped with oxygen.

According to an embodiment of the present disclosure, the sulfide-based solid electrolyte powders may be a compound expressed as following Chemical formula 2.

### 2. ‘S2’

According to an embodiment of the present disclosure, the method for manufacturing the cathode active material includes coating the sulfide-based solid electrolyte powders on the lithium composite metal oxide under the atmosphere of oxygen (O₂) (S2).

According to an embodiment of the present disclosure, as the sulfide-based solid electrolyte powders are coated on the lithium composite metal oxide under the atmosphere of oxygen (O₂), oxygen is doped into the sulfide-based solid electrolyte powders.

According to an embodiment of the present disclosure, the atmosphere of oxygen (O₂) may refer to an atmosphere containing air having the fraction of oxygen ranging from about 10% to about 30% and having a dew point of at most about −50° C.

According to an embodiment of the present disclosure, ‘S2’ may be performed in a hybridizer (impact milling) process.

According to an embodiment of the present disclosure, the hybridizer process is the type of a mechanochemical fusion process to apply stronger mechanical force to a plurality of particles to cause a mechanochemical reaction, such that a plurality of particles are formed. The hybridizer process may be performed by preparing a hybridizer including a chamber provided therein with a high-speed rotator having a plurality of blades, supplying, for example, at least two types of particles of the lithium composite metal oxide and the sulfide-based solid electrolyte powders into the chamber of the hybridizer under the condition of the atmosphere of oxygen, rotating the chamber at a rotating speed ranging from about 5,000 rpm to about 16,000 rpm to disperse the lithium composite metal oxide and the sulfide-based solid electrolyte powders, and applying kinetic energy and thermal energy (for example, compression, friction, and shear stress) to the lithium composite metal oxide and the sulfide-based solid electrolyte powders for a shorter period of time ranging from one minute to ten minutes, preferably, ranging one minute to five minutes.

According to an embodiment of the present disclosure, the sulfide-based solid electrolyte powders doped with oxygen may be coated on the lithium composite metal oxide through the hybridizer process. In addition, the sulfide-based solid electrolyte may be deformed due to the difference in physical property between the lithium composite metal oxide having higher particle strength and the sulfide-based solid electrolyte powders having a softer property. Accordingly, the sulfide-based solid electrolyte powders (that is, the sulfide-based solid electrolyte powders doped with oxygen) may be coated on the lithium composite metal oxide, in an amorphous state.

According to an embodiment of the present disclosure, the coating of the sulfide-based solid electrolyte powders in the amorphous state may be recognized through X-ray diffraction (XRD). In detail, when the sulfide-based solid electrolyte powders are coated in a crystalline state (that is, the sulfide-based solid electrolyte powders are merely adjacent to the lithium composite metal oxide without physically/chemically binding), a peak may be observed in the 20 range from 25 to 26, from 29 to 31, and from 31 to 32 in XRD analysis. However, when the sulfide-based solid electrolyte powders are coated in the amorphous state (that is, the sulfide-based solid electrolyte powders are physical/chemically bound to the lithium composite metal oxide), a peak may not be observed in the 20 range from 25 to 26, from 29 to 31, and from 31 to 32 in XRD analysis.

### <Cathode>

The present disclosure provides a cathode including the cathode active material.

In addition, according to an embodiment of the present disclosure, the cathode may include the cathode active material and the sulfide-based solid electrolyte (LPSCI).

According to an embodiment of the present disclosure, the cathode may be prepared by coating slurry which is obtained as the cathode active material, the sulfide-based solid electrolyte (LPSCI), a binder, and a conductive material are introduced into a solvent, on a base and drying the base. The details of the binder and the conductive material will be described later.

According to an embodiment of the present disclosure, the sulfide-based solid electrolyte (LPSCI), which is not doped with oxygen, may be, in detail, a compound expressed in following Chemical formula 2.

### <All-Solid State Battery>

The present disclosure provides an all-solid state battery including a solid electrolyte free-standing film.

According to an embodiment of the present disclosure, the all-solid state battery may have a structure in which an anode including an anode current collector and an anode active material layer, a solid electrolyte free-standing film, and a cathode including a cathode active material layer and a cathode current collector are stacked on each other.

According to an embodiment of the present disclosure, the anode current collector may be a base provided in the form of a plate having an electrical conductivity. In detail, the anode current collector may have the form of a sheet, a thin film, or a foil.

According to an embodiment of the present disclosure, the anode current collector may include a material which does not react with lithium. In detail, the anode current collector may include at least any one selected from Ni, Cu, stainless steel (SUS), and the combination thereof.

According to an embodiment of the present disclosure, the anode active material layer may include the anode active material, the solid electrolyte, and the binder.

According to an embodiment of the present disclosure, the anode active material is not specifically limited thereto. For example, the anode active material may include a carbon active material and a metal active material.

According to an embodiment of the present disclosure, the carbon active material may be mesocarbon microbeads (MCMB), graphite, such as highly oriented graphite (HOPG), or amorphous carbon such as hard carbon, and soft carbon.

According to an embodiment of the present disclosure, the metal active material may be In, Al, Si, and Sn, and an alloy containing at least one element of In, Al, Si, and Sn.

According to an embodiment of the present disclosure, the solid electrolyte may be an oxide-based solid electrolyte or a sulfide-based solid electrolyte, and preferably the sulfide-based solid electrolyte among the oxide-based solid electrolyte and the sulfide-based solid electrolyte. The details of the sulfide-based solid electrolyte have been described above. Accordingly, the details thereof will be omitted below.

According to an embodiment of the present disclosure, the conductive material is a component to form an electron transferring path within the electrode. The conductive material may be a sp² carbon material, such as carbon black, conducting graphite, ethylene black, and carbon nanotube, or graphene.

According to an embodiment of the present disclosure, the binder may include butadiene rubber (BR), nitrile butadiene rubber (NBR), hydrogenated nitrile butadiene rubber (HNBR), polyvinylidene difluoride (PVDF), polytetrafluoroethylene (PTFE), or carboxymethylcellulose (CMC).

According to an embodiment of the present disclosure, the cathode active material layer may include the cathode active material, the solid electrolyte, the conducive material, and the binder.

According to an embodiment of the present disclosure, the cathode active material has been described above, and the details thereof will be omitted below.

According to an embodiment of the present disclosure, the solid electrolyte may be an oxide-based solid electrolyte or a sulfide-based solid electrolyte. It may be preferred that the solid electrolyte may include the sulfide-based solid electrolyte having a higher lithium ion conductivity.

According to an embodiment of the present disclosure, the conductive material and the binder have been described above, and the details thereof will be omitted below.

According to an embodiment of the present disclosure, the cathode current collector may be a base provided in the form of a plate having an electrical conductivity. In detail, the cathode current collector may have the form of a sheet or a thin film.

According to an embodiment of the present disclosure, the cathode current collector may include at least any one selected from the group consisting of indium, copper, magnesium, aluminum, stainless steel, iron, and the combination thereof.

According to an embodiment of the present disclosure, the solid electrolyte free-standing film is positioned between the anode active material layer and the cathode active material layer to transfer a lithium ion.

Hereinafter, an embodiment of the present disclosure will be described in detail such that those skilled in the art may easily reproduce the embodiment of the present disclosure. However, the present disclosure may be implemented in various forms, and is limited to embodiments described herein.

### Example 1

### <Preparation of Lithium Composite Metal Oxide>

The lithium composite metal oxide of LiNi_{0.8}Co_{0.1}Mn_{0.1}O₂ was prepared, LiOH and Nb ethoxide were dissolved at a molar ratio of 1:1 in an alcohol solvent, and then the alcohol solvent was mixed together with the lithium composite metal oxide of LiNi_{0.8}Co_{0.1}Mn_{0.1}O₂. Thereafter, the mixture was dried and subject to heat treatment at the temperature ranging from 300° C. to 500° C. for one hour, thereby preparing the lithium composite metal oxide of LiNi_{0.8}Co_{0.1}Mn_{0.1}O₂ having an average particle diameter (D₅₀) ranging from about 3 μm to about 5 μm and coated with LiNbO₃.

### <Preparation of Cathode Active Material>

100 wt parts of the prepared lithium composite metal oxide and 0.2 wt parts of solid electrolyte powders of Li₆PS₅Cl were introduced into a reactor. Then, the hybridizer coating process was performed under conditions of the rotating speed ranging from about 5000 rpm to about 15000 rpm, and a process time of one minute at the atmosphere of oxygen, thereby manufacturing the cathode material.

### Example 2

The cathode active material was manufactured in a method the same as that of Example 1, except that 100 wt parts of the prepared lithium composite metal oxide and 4 wt parts of solid electrolyte powders of Li₆PS₅Cl were introduced into the reactor, and the hybridizer coating process was performed.

### Comparative Example 1

The lithium composite metal oxide of LiNi_{0.8}Co_{0.1}Mn_{0.1}O₂ was prepared, LiOH and Nb ethoxide were dissolved at a molar ratio of 1:1 in an alcohol solvent, and then the alcohol solvent was mixed together with the lithium composite metal oxide of LiNi_{0.8}Co_{0.1}Mn_{0.1}O₂. Thereafter, the mixture was dried and subject to heat treatment at the temperature ranging from 300° C. to 500° C. for one hour, thereby manufacturing the cathode active material having the composition of LiNi_{0.8}Co_{0.1}Mn_{0.1}O₂ having an average particle diameter (D₅₀) ranging from 3 μm to 5 μm and coated with LiNbO₃.

### Comparative Example 2

The cathode active material was manufactured in a method the same as that of Example 1, except that the hybridizer coating process was performed under the atmosphere of inert gas (Ar).

### Reference Example 1

100 wt parts of the cathode active material manufactured in Comparative example 1, and 4 wt parts of solid electrolyte powders of Li₆PS₅Cl having an average particle diameter (D₅₀) of 1 μm were mixed.

### Reference Example 2

100 wt parts of the cathode active material manufactured in Comparative example 1, and 7 wt parts of solid electrolyte powders of Li₆PS₅Cl having an average particle diameter (D₅₀) of 1 μm were mixed.

### Experimental Example 1—EDS Analysis

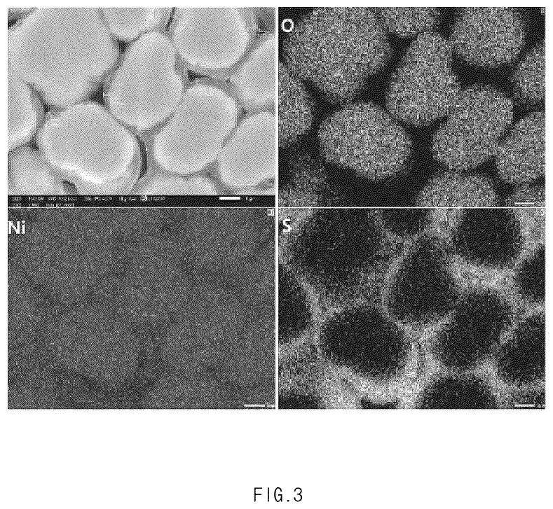

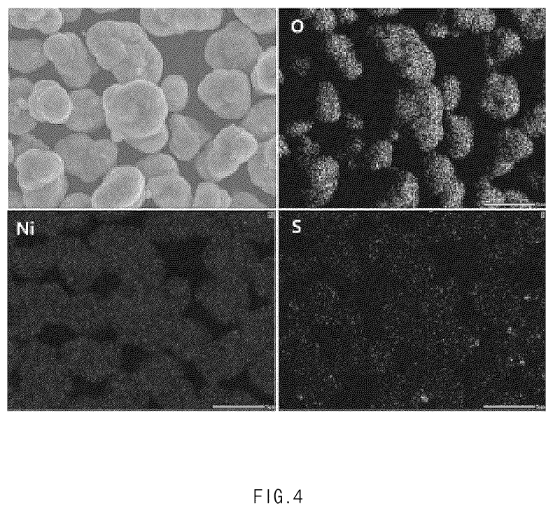

EDS analysis (acceleration voltage of 5 kv; measurement equipment: JSM-7200F, JEOL Co., Ltd.) was performed on each of the cathode active materials prepared in Example 1 and Comparative Example 2, and the results thereof are shown in FIGS. 3 and 4.

FIG. 3 is an image illustrating an EDS analysis result for the cathode active material of Example 1, and FIG. 4 is an image illustrating an EDS analysis result for the cathode active material of Comparative example 2. Referring to FIGS. 3 and 4, it may be recognized that oxygen was detected based on the EDS analysis result, in Example 1 employing the hybridizer coating process performed under the atmosphere of oxygen, while oxygen was not detected from a portion of the lithium composite metal oxide coated with the solid electrolyte, except for oxygen provided in the lithium composite metal oxide, based on the EDS analysis result, in Comparative example 2 employing the hybridizer coating process performed under the atmosphere of inert gas (Ar).

### Experimental Example 2—XPS Analysis

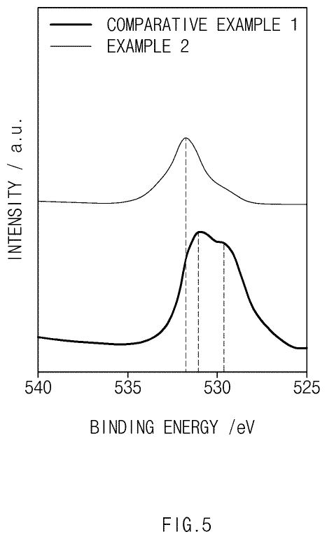

XPS analysis (VG Multilab ESCA system; 220i) was performed, in a dry room, with respect to each of the cathode active materials manufactured in Example 2 and Comparative example 1, and the result is shown in FIG. 5.

FIG. 5 is a graph illustrating an XPS analysis result for each of the cathode active materials manufactured Example 2 and Comparative example 1.

Referring to FIG. 5, it may be recognized that a peak (near 529 eV) for oxygen bound with Li and a peak (near 531 eV) caused by LiNbO₃ were observed, in Comparative example 1 in which the solid electrolyte doped with oxygen is not coated. Meanwhile, it may be recognized that a peak (near 529 eV) for oxygen bound with Li and a peak (near 531 eV) caused by LiNbO₃ were not observed, although a peak (near 532 eV) caused by Thiophosphate (PS₃O³⁻) was observed, in Example 2 in which the solid electrolyte doped with oxygen is coated.

### Experimental Example 3—XRD Analysis

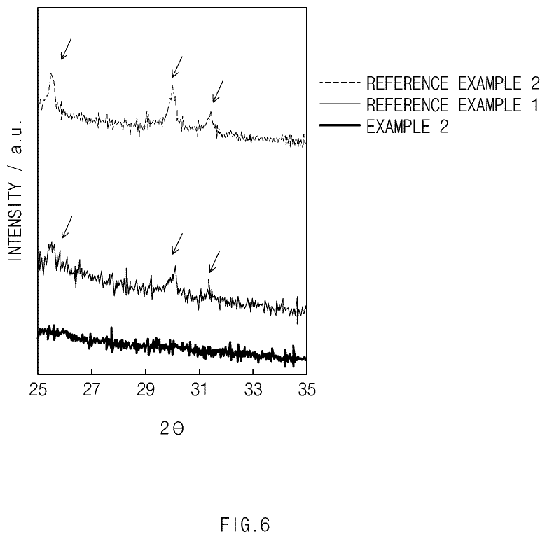

With respect to each of the cathode active materials manufactured in Example 2, and Reference examples 1 and 2, an XRD spectrum was measured under conditions of CuKα, 2θ (Bragg angle)=25°-35°, scan speed=5°/1 min, through Empyrean diffractometer (Malvern Panalytical Ltd), and the result thereof is shown in FIG. 6

FIG. 6 is a graph illustrating an XRD analysis result for each of cathode active materials manufactured in Example 2, and Reference examples 1 and 2.

Referring to FIG. 6, it may be recognized that a peak appeared by a solid electrolyte having a crystal shape was observed, in Reference example 1 and 2 in which the lithium composite metal oxide and the solid electrolyte were merely mixed without the hybridizer coating process.

Meanwhile, in Example 2 in which the solid electrolyte was coated on the lithium composite metal oxide through the hybridizer coating process, the hybridizer coating process went through the collision between particles derived from gas. In this case, the solid electrolyte may be deformed due to the difference in physical property between the lithium composite metal oxide having higher particle strength and the sulfide-based solid electrolyte powders having a softer property. Accordingly, the solid electrolyte powders may be coated on the surface of the lithium composite metal oxide, in an amorphous state. This is because the peak appeared by the solid electrolyte having the crystal shape was not observed in the cathode active material of Example 2, as the solid electrolyte was coated on the surface of the lithium composite metal oxide, in an amorphous-like shape, as illustrated in FIG. 6.

### Experimental Example 4—Battery Evaluation

A cathode was manufactured by additionally mixing 85 wt parts of cathode active material (except for a solid electrolyte layer), 14 wt parts of sulfide-based solid electrolyte of Li₆PS₅Cl (the solid electrolyte layer and/or solid electrolyte powders), one wt part of conductive material (carbon black), and one wt part of binder (PTFE), with respect to each of the cathode active materials manufactured Example 1 and Comparative example 1.

0.15 g of the sulfide-based solid electrolyte powders of Li₆PS₅Cl were put into a Polyether ether ketone (PEEK) mold having the diameter of 13 mm, and was pressed under pressure of 1 ton for one minute. Thereafter, the manufactured cathode was put and pressed under pressure of 7 ton for one minute. In addition, after a Li_{0.5}In film was provided in place of an anode, binding was made under pressure of 60 Mpa, thereby manufacturing each all-solid state battery.

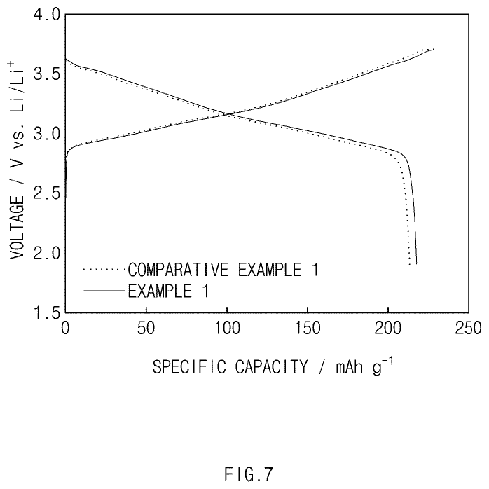

With respect to each the all-solid state battery manufactured, after an upper limit voltage was charged up to 3.7 V with a constant current of 0.1 C, a discharging ending voltage was discharged to 1.9 V with the constant current of 0.1 C at the temperature of 60° C. The graph of such a charging/discharging capacity is illustrated in FIG. 7. In addition, a 0.1 C charging capacity, a 0.1 C discharging capacity, and a charging/discharging efficiency, which is the ratio of the discharging capacity to the charging capacity, is shown in following Table 1.

TABLE 1

| | Specific capacity | | Areal capacity | | Charging/ |
|---|---|---|---|---|---|
| | (mAh/g) | | (mAh/cm²) | | discharging |
| | | Dis- | | Dis- | efficiency |
| | Charging | charging | Charging | charging | (%) |
| Example 1 | 227.42 | 217.8 | 8.83 | 8.46 | 95.77 |
| Compar- | 224.44 | 213.81 | 8.65 | 8.24 | 95.26 |
| ative | | | | | |
| example 1 | | | | | |

FIG. 7 is a graph illustrating a charging/discharging capacity of each all-solid state battery manufactured using the cathode active material manufactured in Example 1 and Comparative example 1.

Referring to FIG. 7 and Table 1, it may be recognized that the solid electrolyte layer including the solid electrolyte doped with oxygen slightly improved the charging/discharging efficiency, without degrading the initial capacity and efficiency.

### Experimental Example 5—Evaluation for Higher-Temperature Stability

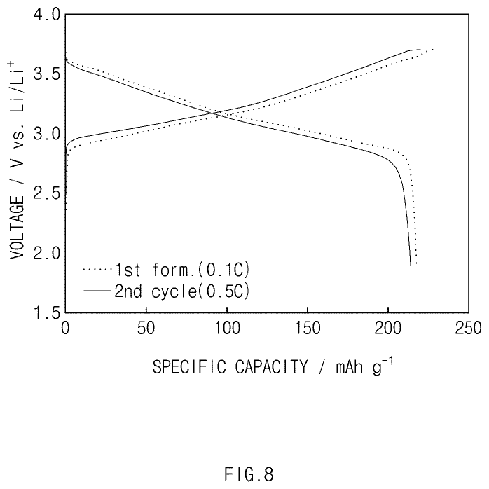

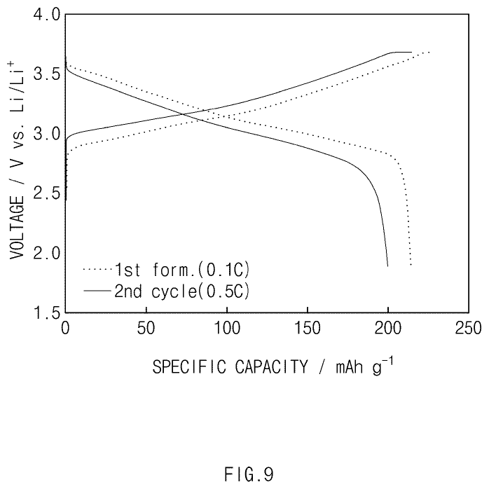

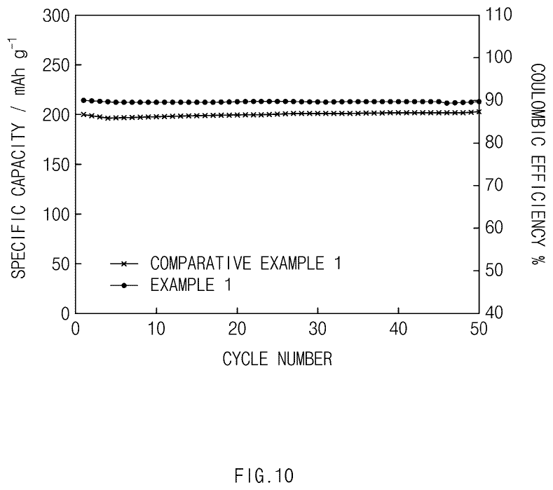

With respect to the all-solid state battery manufactured in Experimental example 3, a first cycle was performed by charging an upper limit voltage up to 3.7 V with a constant current of 0.1 C, and discharging a discharging ending voltage to 1.9 V with the constant current of 0.1 C at the temperature of 60° C. From a second cycle, a constant current of 0.5 C was applied. Graphs of such a charging/discharging capacity are illustrated in FIGS. 8 and 9. In addition, 50 cycles was performed with the constant current of 0.5 C. A graph illustrating the change in capacity as a function of a cycle number is illustrated in FIG. 10.

FIG. 8 is a graph illustrating a charging/discharging capacity in each cycle when a first cycle is performed with 0.1 C/0.1 C, and a second cycle is performed with 0.5 C/0.5 C at the temperature of 60° C. with respect to an all-solid state battery manufactured using the cathode active material manufactured in Example 1. FIG. 9 is a graph illustrating a charging/discharging capacity in each cycle when the first cycle is performed with 0.1 C/0.1 C, and the second cycle is performed with 0.5 C/0.5 C at the temperature of 60° C. with respect to an all-solid state battery manufactured using the cathode active material manufactured in Comparative example 1. FIG. 10 is a graph illustrating the change in capacity as a function of a cycle number when a cycle of 0.5 C/0.5 C was performed 50 times at the temperature of 60° C., with respect to each of all-solid state batteries manufactured using cathode active materials manufactured in Example 1 and Comparative example 1.

Referring to FIGS. 8 to 10, it may be recognized that Example 1 having the solid electrolyte layer including the sulfide-based solid electrolyte doped with oxygen maintained a higher capacity and a lower resistance and more improved a cycle characteristic at the higher temperature of 60° C., thereby more improving higher-temperature stability, when compared with Comparative example 1 having no solid electrolyte layer.

### Experimental Example 6—Evaluation for C-Rate

A cathode was manufactured by additionally mixing 85 wt parts of cathode active material, 14 wt parts of sulfide-based solid electrolyte of Li₆PS₅Cl, 1 wt part of conductive material (carbon black), and 1 wt part of binder (PTFE), with respect to each of the cathode active materials manufactured Example 1, Comparative example 1, and Comparative example 2.

0.15 g of the sulfide-based solid electrolyte powders of Li₆PS₅Cl was put into a Polyether ether ketone (PEEK) mold having the diameter of 13 mm, and was pressed under pressure of 1 ton for one minute. Thereafter, the manufactured cathode was put and pressed under pressure of 7 ton for one minute. In addition, after a Li_{0.5}In film was provided in place of an anode, binding was made under pressure of 60 Mpa, thereby manufacturing each all-solid state battery.

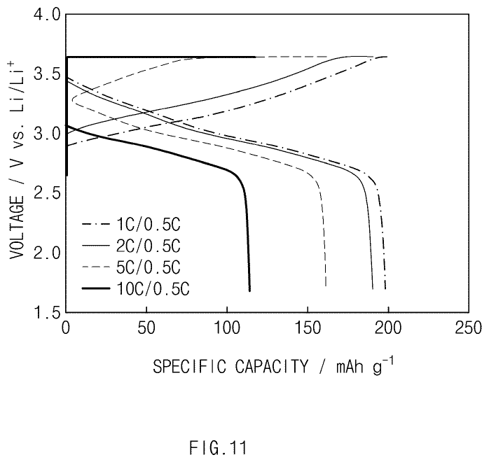

With respect to each the all-solid state battery manufactured, an upper limit voltage was charged up to 3.7 V with a constant current of 0.1 C, and a discharging ending voltage was discharged to 1.9 V with the constant current of 0.1 C, at the temperature of 60° C., thereby performing a formation process. In addition, charging was performed by changing a rate to 1 C, 2 C, 5 C, and 10 C step by step, and discharging was performed at the rate of 0.5 C. Graphs of such a charging/discharging capacity are illustrated in FIGS. 11 to 13, and an available capacity is shown in table 2.

TABLE 2

| | Reversible capacity (mAh/g) | | | |
|---|---|---|---|---|
| | 1 C/0.5 C | 2 C/0.5 C | 5 C/0.5 C | 10 C/0.5 C |
| | cycle | cycle | cycle | cycle |
| Example 1 | 198.1 | 190.1 | 161.5 | 114.2 |
| Comparative | 194.6 | 185.1 | 146.2 | 94.3 |
| example 1 | | | | |
| Comparative | 192.1 | 179.2 | 130.2 | 80.5 |
| example 2 | | | | |

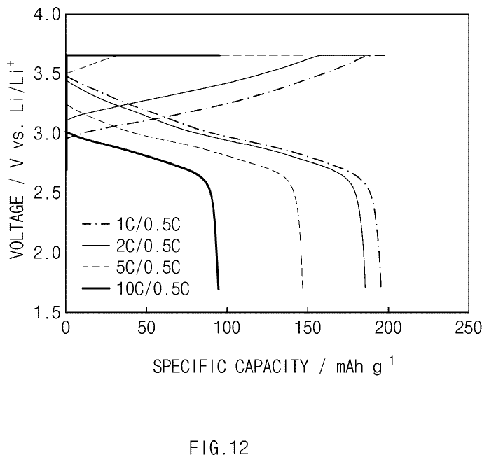

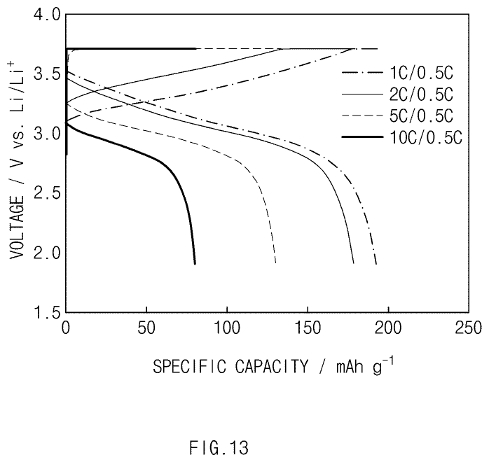

FIG. 11 illustrates a graph of a charging/discharging capacity, as charging was performed by changing a rate to 1 C, 2 C, 5 C, and 10 C step by step, and discharging was performed at the rate of 0.5 C, with respect to the all-solid state battery manufactured using the cathode active material manufactured by Example 1. FIG. 12 illustrates a graph of a charging/discharging capacity, as charging was performed by changing a rate to 1 C, 2 C, 5 C, and 10 C step by step, and discharging was performed at the rate of 0.5 C, with respect to the all-solid state battery manufactured using the cathode active material manufactured in Comparative example 1. FIG. 13 illustrates a graph of a charging/discharging capacity, as charging was performed by changing a rate to 1 C, 2 C, 5 C, and 10 C step by step, and discharging was performed at the rate of 0.5 C, with respect to the all-solid state battery manufactured using the cathode active material manufactured in Comparative example 2.

Referring to FIGS. 11 to 13, it may be recognized that Example 1 was greater than Comparative examples 1 and 2 in reversible capacity measured when the charging was performed by charging the rate to 1 C, 2 C, 5 C, and 10 C step by step.

According to an example of the present disclosure, the cathode active material may contribute to suppressing a side reaction made on the interface between the cathode material and the solid electrolyte, reducing the internal resistance of the electrode, and improving higher-temperature stability and performance of the cathode material.

According to an example of the present disclosure, the method for manufacturing the cathode active material may contribute to suppressing a side reaction made on the interface between the cathode material and the solid electrolyte, reducing the internal resistance of the electrode, and improving higher-temperature stability and performance of the cathode material.

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A cathode active material comprising:
a core including a lithium composite metal oxide; and
a solid electrolyte layer provided on the core,
wherein the solid electrolyte layer includes a sulfide-based solid electrolyte doped with oxygen.

2. The cathode active material of claim 1, wherein a weight of the solid electrolyte layer ranges from 0.01 wt % 10 to 6 wt %, based on a whole weight of the lithium composite metal oxide.

3. The cathode active material of claim 1, wherein the solid electrolyte layer has a peak within a range from 532.5 eV to 533 eV, when the solid electrolyte layer is analyzed through an X-ray photoelectron spectroscopy (XPS).

4. The cathode active material of claim 1, wherein the sulfide-based solid electrolyte doped with the oxygen includes thiophosphate (PS₃O³⁻).

5. The cathode active material of claim 1, wherein the core is obtained by coating LiNbO₃ on the lithium composite metal oxide.

6. The cathode active material of claim 1, wherein the solid electrolyte layer has a thickness less than or equal to 200 nm.

7. A cathode comprising the cathode active material of claim 1 and a sulfide-based solid electrolyte.

8. The cathode of claim 7, wherein the sulfide-based solid electrolyte is not doped with oxygen.

9. The cathode of claim 7, wherein the sulfide-based solid electrolyte is expressed as following Chemical formula 2,
Li₇₋ₐPS₆₋ₐXₐ, [Chemical formula 2]
in which 0≤a≤2 and ‘X’ is one of Cl, Br, or I in Chemical formula 2.

10. A method for manufacturing a cathode active material, the method comprising:
preparing a lithium composite metal oxide and sulfide-based solid electrolyte powders (S1); and
coating the sulfide-based solid electrolyte powders on the lithium composite metal oxide under an atmosphere of oxygen (O₂) (S2).

11. The method of claim 10, wherein ‘S2’ is performed a hybridizer process.
